(19) United States
(12) Patent Application Publication
(10) Pub. No.: US 2012/0303417 A1
(43) Pub. Date: Nov. 29, 2012

(54) REALTIME PRICE SYTEM

(75) Inventor: Luke Yeh, Los Angeles, CA (US)

(73) Assignee: Yahoo! Inc., Sunnyvale, CA (US)

(21) Appl. No.: 13/116,444

(22) Filed: May 26, 2011

(51) Int. Cl. G06Q 30/00

(52) U.S. Cl. 705/7.35

(57) ABSTRACT

A system and method for real-time pricing includes: receiving current sales data for an item; storing the current sales data; calculating a current sales lag time as a time elapsed between the sale of the item and a previous sale of the item; comparing the current sales lag time with a stored historical sales lag time; determining that the sales lag time is increasing when the current sales lag time is greater than the stored historical sales lag time of the item; and recommending a decrease in the sales price of the item when it is determined that the sales lag time increasing.

### CROSS-REFERENCE TO RELATED APPLICATIONS

None.

### STATEMENT REGARDING FEDERALLY SPONSORED-RESEARCH OR DEVELOPMENT

None.

### INCORPORATION BY REFERENCE OF MATERIAL SUBMITTED ON A COMPACT DISC

None.

### FIELD OF THE INVENTION

The invention disclosed broadly relates to the field of e-commerce, and more particularly relates to the field of pricing in an on-line marketplace.

### BACKGROUND OF THE INVENTION

Inefficiencies exist in certain ultra competitive, high volume marketplaces where entire purchase and pricing decisions are made in a matter of minutes. Suppliers in these marketplaces could benefit from near-real time pricing adjustments to maximize sales. Standard market analysis that occurs over the period of one month to several months may be sufficient to cover a macro level pricing adjustment but can result in the loss of short term sales in the fast-paced, highly competitive setting of an on-line marketplace.

Pricing adjustments need to occur rapidly to maintain an edge in today's increasingly global marketplace. Current methods of adjusting price, based on the traditional supply and demand paradigm of macro-economics, do not take into consideration the shopping savvy of modern price-conscious consumers.

Therefore there is a need for a method to automate pricing adjustments in order to overcome the above-stated shortcoming of the known art.

### SUMMARY OF THE INVENTION

Briefly, according to an embodiment of the invention a method for real-time pricing includes steps or acts of: receiving through an input/output interface current sales data for an item; storing the current sales data; calculating a current sales lag time as a time elapsed between the sale of the item and a previous sale of the item; comparing the current sales lag time with a stored historical sales lag time; determining that the sales lag time is increasing when the current sales lag time is greater than the stored historical sales lag time of the item; and recommending a decrease in the sales price of the item when it is determined that the sales lag time is increasing.

The method for real-time sales pricing can also include: determining that the sales lag time is decreasing when the current sales lag time is less than the stored historical sales lag time of the item; and recommending an increase in the sales price of the item when the current sales lag time is lower than the stored historical sales lag time of the item. The method for real-time sales pricing can also include determining that the increase/decrease in the sales price of the item does place the increased/decreased sales price above/below an upper/lower limit price cap.

In one embodiment of the present invention, the method for real-time sales pricing can also include storing the historical sales lag time as the sales lag time between a last sale of the item and a penultimate sale of the item. In another embodiment of the present invention, the historical sales lag time is an average of sales lag times for sales of the item during a specified period of time.

In one embodiment of the present invention, the method for real-time sales pricing can include monitoring a competitor's customer queue and basing a price adjustment on the size of a competitor's queue.

According to another embodiment of the present invention, a system for real-time pricing includes: an input/output interface configured to receive current sales data for an item; a memory for storing computer executable instructions, and a processor device operably coupled with the memory. The processor device executes the instructions which cause a computer to perform the method steps for a real-time pricing system.

According to another embodiment of the present invention, a computer-readable storage medium contains computer executable instructions that when executed cause a computer to perform the method steps for real-time pricing.

The method can also be implemented as machine executable instructions executed by a programmable information processing system or as hard coded logic in a specialized computing apparatus such as an application-specific integrated circuit (ASIC).

### BRIEF DESCRIPTION OF THE SEVERAL VIEWS OF THE DRAWINGS

To describe the foregoing and other exemplary purposes, aspects, and advantages, I use the following detailed description of an exemplary embodiment of the invention with reference to the drawings, in which:

FIG. 1 is a high level block diagram showing an information processing system configured to operate according to an embodiment of the present invention;

FIG. 2 is a flowchart of a method according to an embodiment of the present invention;

FIG. 3 is a flowchart of a method according to another embodiment of the present invention;

FIG. 4 is a data flow diagram of a method for real-time pricing according to an embodiment of the present invention; and

FIG. 5 is a simplified depiction of an aggregator site, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

Before describing in detail embodiments that are in accordance with the present invention, it should be observed that the embodiments reside primarily in combinations of method steps and system components related to systems and methods for placing computation inside a communication network. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

I describe a real-time pricing solution that uses an automated computer system to recommend and make automated pricing adjustments (with or without human input). In an embodiment of the present invention, as will be described more fully below, in high volume marketplaces, the price adjustments are made according to any number of inputs including the time between sales (sales lag time), the lag time between sales on a competitor's or third party's site, the volume of sales on my site or a competitor's site (e.g., a large volume of sales could be used as a factor in deciding to increase prices). For example, if a large or increasing gap of time exists between sales, prices may be lowered. Conversely, if sales are occurring repeatedly, prices may be adjusted upward to a set cap.

I use a real-time feedback loop which takes as input the seller's sales data, including the sales lag time, and uses that input to determine if a pricing adjustment would be beneficial in increasing sales. In additional, the real-time feedback loop can take as input a competitor's sales volume and/or customer queue. Thus in addition to a seller's own sales data, the system can consider the competitor's sales volume and the number of customers waiting in a competitor's queue. If the size of the competitor's queue is larger than the seller's own queue, it may be beneficial for the seller to lower prices to entice the competitor's customers.

This particular embodiment can be especially advantageous in a brick-and-mortar environment such as, for example, a food court in a shopping mall. In a food court, various restaurants operate side-by-side and share a common dining area. Customers line up at the restaurant of their choice. To speed up the ordering process, the restaurants post the food items and their prices on a menu board that is visible to the customers waiting in queue. A restaurant employee can easily input the number of customers in a competitor's queue. The system takes this additional input and factors it into the price adjustment process. For example, if your competitor shows a long line of customers and the timing between your sales is increasing, your menu board can be configured to automatically lower the prices for some or all of your menu items. Over time, customers become trained to spot these price decreases. When customers return and the timing between sales transactions goes back down, prices can be set to automatically increase.

This invention also has advantages for real-time pricing in an e-commerce setting, particularly in aggregator sites for near commodity-like items such as diapers and printer paper. For example, at shopzilla or Shopping.com, or any other on-line comparison shopping sites, savvy shoppers search for products to buy and can compare prices. A seller of an item has the same access to pricing information as the shoppers. The seller can therefore acquire data for the pricing offered by a competitor (e.g., through any number of automated mechanisms, such as robots or scraping) and compare it against the pricing and volume of its own sales to arrive at an optimum pricing.

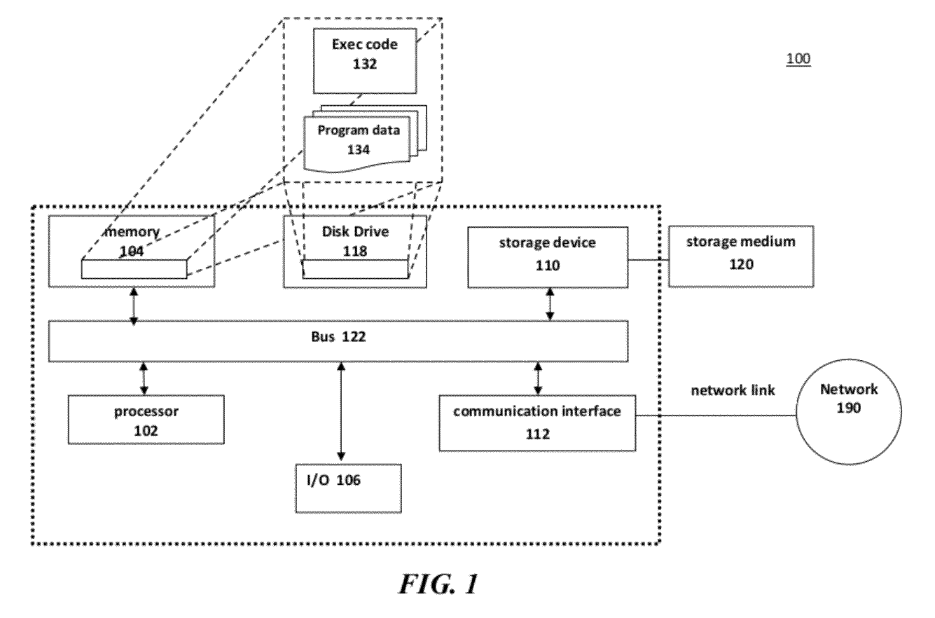

### FIG. 1

### System Embodiment

Referring now in specific detail to the drawings, and particularly FIG. 1, there is provided a simplified pictorial illustration of an information processing system for real-time pricing in which the present invention may be implemented. For purposes of this invention, computer system 100 may represent any type of computer, information processing system or other programmable electronic device, including a client computer, a server computer, a portable computer, an embedded controller, a personal digital assistant, and so on. The computer system 100 may be a stand-alone device or networked into a larger system. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like.

In general, the routines which are executed when implementing these embodiments, whether implemented as part of an operating system or a specific application, component, program, object, module or sequence of instructions, will be referred to herein as computer programs, or simply programs. The computer programs typically comprise one or more instructions that are resident at various times in various memory and storage devices in an information processing or handling system such as a computer, and that, when read and executed by one or more processors, cause that system to perform the steps necessary to execute steps or elements embodying the various aspects of the invention.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing device 102 which communicates with an input/output subsystem 106, memory 104, storage 110 and network 110. The processor device 102 is operably coupled with a communication infrastructure 122 (e.g., a communications bus, cross-over bar, or network). The processor device 102 may be a general or special purpose microprocessor operating under control of computer program instructions 132 executed from memory 104 on program data 134. The processor 102 may include a number of special purpose sub-processors such as a comparator engine, each sub-processor for executing particular portions of the computer program instructions. Each sub-processor may be a separate circuit able to operate substantially in parallel with the other sub-processors.

Some or all of the sub-processors may be implemented as computer program processes (software) tangibly stored in a memory that perform their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips.

The memory 104 may be partitioned or otherwise mapped to reflect the boundaries of the various memory subcomponents. Memory 104 may include both volatile and persistent memory for the storage of: operational instructions 132 for execution by CPU 102, data registers, application storage and the like. Memory 104 preferably includes a combination of random access memory (RAM), read only memory (ROM) and persistent memory such as that provided by a hard disk drive 118. The computer instructions/applications that are stored in memory 104 are executed by processor 102. The computer instructions/applications 132 and program data 134 can also be stored in hard disk drive 118 for execution by processor device 102. Memory 104.

The I/O subsystem 106 may comprise various end user interfaces such as a display, a keyboards, and a mouse. The I/O subsystem 106 may further comprise a connection to a network 190 such as a local-area network (LAN) or wide-area network (WAN) such as the Internet.

The computer system 100 may also include a removable storage drive 110, representing a floppy disk drive, a magnetic tape drive, an optical disk drive, etc. The removable storage drive 110 reads from and/or writes to a removable storage unit 120 in a manner well known to those having ordinary skill in the art. Removable storage unit 120, represents a floppy disk, a compact disc, magnetic tape, optical disk, CD-ROM, DVD-ROM, etc. which is read by and written to by removable storage drive 110. As will be appreciated, the removable storage unit 120 includes a non-transitory computer readable medium having stored therein computer software and/or data.

The computer system 100 may also include a communications interface 112. Communications interface 112 allows software and data to be transferred between the computer system and external devices. Examples of communications interface 112 may include a modem, a network interface (such as an Ethernet card), a communications port, a PCMCIA slot and card, etc. Software and data transferred via communications interface 112 are in the form of signals which may be, for example, electronic, electromagnetic, optical, or other signals capable of being received by communications interface 112.

In this document, the terms “computer program medium,” “computer usable medium,” and “computer readable medium” are used to generally refer to both transitory and non-transitory media such as main memory 104, removable storage drive 120, a hard disk installed in hard disk drive 118, and signals. These computer program products are means for providing software to the computer system 100. The computer readable medium 120 allows the computer system 100 to read data, instructions, messages or message packets, and other computer readable information from the computer readable medium 120.

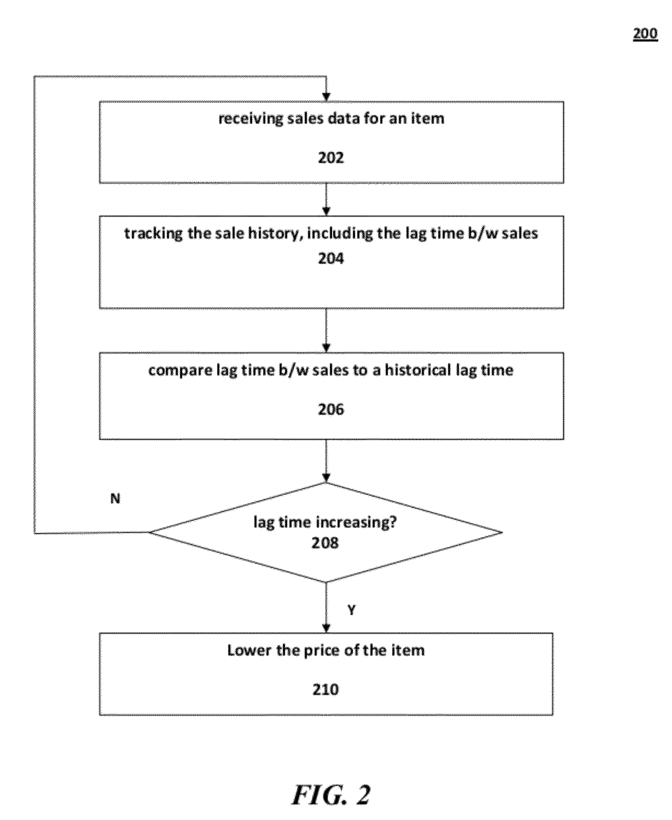

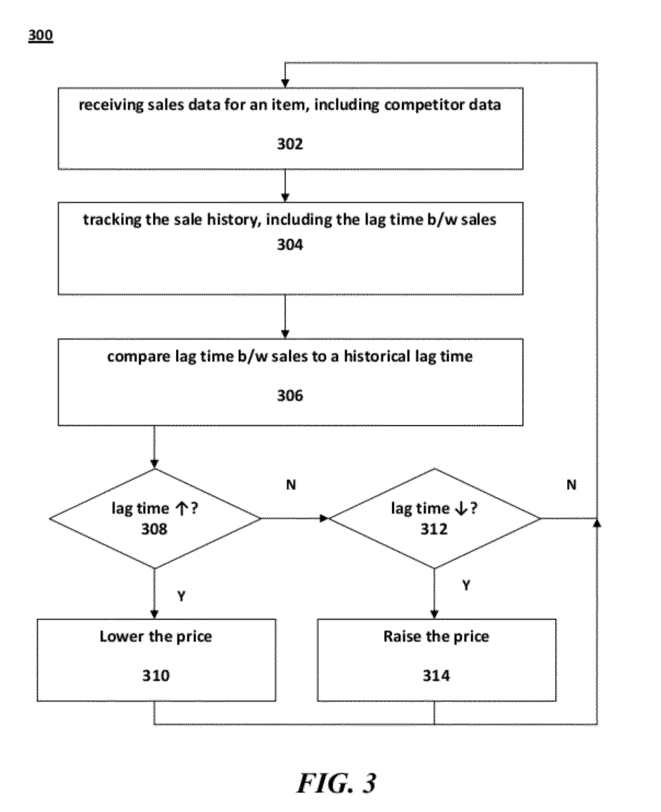

### FIGS. 2 and 3

### Method Embodiments

The flowcharts and block diagrams depicted herein illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Referring now to FIG. 2, I provide a flow chart 200 of a method for implementing a real-time price system, according to an embodiment of the present invention. The method begins at step 202 with the receipt of input, such as sales data. The sales data includes at least: an identifier of the product sold, the sales price, and a timestamp of the time of sale. The input may also include data about a competitor's sales, such as pricing and the length of a competitor's queue.

In step 204 I track the sale history for each sale item. Alternatively, I can designate some items whose sales are more price-driven and select only those items for tracking. Tracking the sale history includes tracking the sales lag time per sales transaction and tracking any changes in sales lag time. For example, it may be important to note if time between sales transactions has gone up from 15 seconds to over 1 minute.

In step 206 I compare the current sales lag time to a historical sales lag time. This historical sales lag time may be a recorded sales lag time from a previous month, week, day, hour, even minute (if sales are high-volume). The time period selected for tracking the historical sales lag may depend on factors such as the type of product, the sales volume of the product, the sales volume of the product by a competitor, and the sales venue. The type of product influences the decision because products that are sold as commodities (such as diapers and printer paper) are far more price-driven than other products. The sales venue influences the decision because a product offered for sale in on-line sites such as Amazon.com, shopzilla and other well-known sites, is offered for sale along with the products of competitors who must all compete for business from increasingly savvy e-customers.

In decision 208, the historical sales lag time and the current sales lag time are compared. The sales lag time is increasing if the current sales lag time is greater than the historical sales lag time. If the sales lag time is increasing, I lower the price of the item in step 210. The process then loops back to step 202 to receive input for the next sales transaction.

Other examples of the types of inputs that can be used to alter a price of an item include: the number of items already sold (e.g., as provided by Groupon and Living Social in their advertisements); the number of items remaining (e.g., as provided by sites like Amazon); the total number of listings (e.g., the number of unique items offered for sale by the universe of sellers at any given time on a particular platform) posted on a site such as eBay; whether a particular item is “in-stock” or “currently unavailable;” the length of time an item is on “back order;” or the total number of bids for an item on an auction platform (e.g., a large number of bids can serve as a proxy for lag time).

Another embodiment of the present invention is shown in FIG. 3. Steps 302, 304, 306, 308, and 310 are equivalent to steps 202, 204, 206, 208, and 210 of FIG. 2. The method differs at step 312 which is the NO branch from step 308. At decision 312 it is determined if the sales lag time is decreasing. If the sales lag time is decreasing, this indicates that sales are increasing. In this case, I consider raising the price at step 314. The process then loops back to step 302.

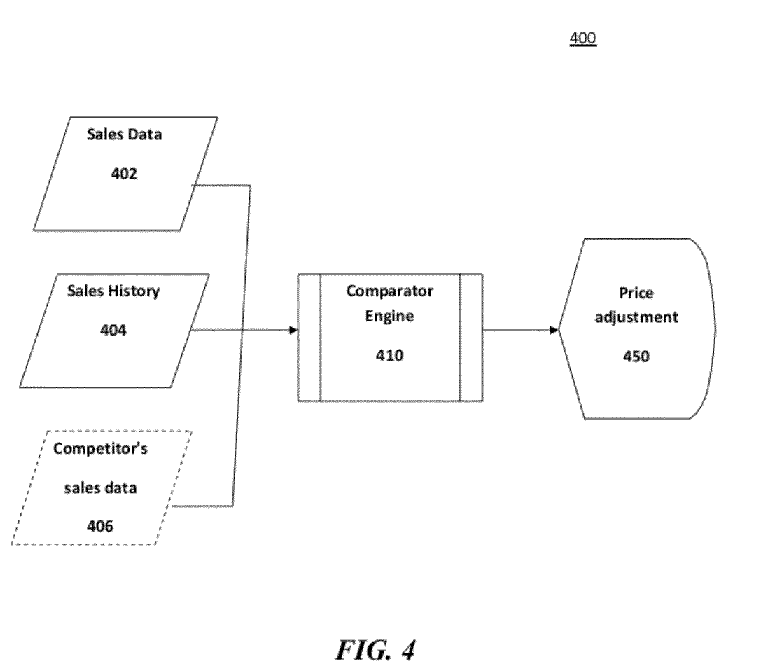

### FIG. 4

### Data Flow Diagram

Referring now to FIG. 4 I show a process/data flow diagram 400 of a method for implementing a real-time price system, according to an embodiment of the present invention. The inputs to the process are the sales data 402 and sales history 404. Optionally, competitors' sales data 406 such as the competitor's sales volume and/or customer queues, can also be used as input. The sales history 404 includes a temporal history of sales of the product for a specified period of time. The temporal history includes a calculation of time between sales (the sales lag time).

In one example, the sales lag time is recorded for a specified period of time and then averaged out for that period of time. For example, suppose that sales lag time is recorded for a one-day period that included five sales of an item at $12.00. The time between each of the five sales was recorded as 2 hours (between sales 1 and 2), 2.5 hours (between sales 2 and 3), 1.8 hours (between sales 3 and 4), and 2.2 hours (between sales 4 and 5). The average sales lag time for the specified one-day period is 2.125.

In another example, only the sales lag time between the last sale and the penultimate sale is stored as the historical sales lag time. The next time a sale is made, the sales lag time between the last sale and the current sale is calculated and stored. All other previously recorded sales lag times can be flushed from the system, leaving only the historical sales lag time and the current sales lag time. The next time a sale is made, the current lag time will replace the historical lag time and a new current sales lag time will be calculated and stored.

The sales data 402, sales history 404, and competitor sales data 406 is input into a comparator engine 410 for comparing the historical sales lag time to the current sales lag time. In the most basic example, if the current sales lag time is greater than the historical sales lag time, the price is dropped. Additionally, if the current sales lag time is lower than the historical sales lag time, the price may be increased.

In some cases it may be beneficial to store a period of recent sales lag times for comparison to a historical sales lag time, rather than just one current sales lag time. This is especially beneficial in the case where an increased sales lag time prompts a price decrease. The price decrease has the desired effect of increasing sales. The seller may not want to immediately increase the price in response to the increased rate of sales, particularly if the brisk sales are due to the lowered price.

It should be noted that before increasing or dropping a price of an item, an upper and lower price cap should be set beyond which the price cannot be lowered and/or raised. The amount that the price should be increased or decreased may be in pre-selected increments, such as for example, $0.50 increments. The output 450 for the process is an instruction to lower or raise the price. Additionally, the system can be configured to execute the price adjustment.

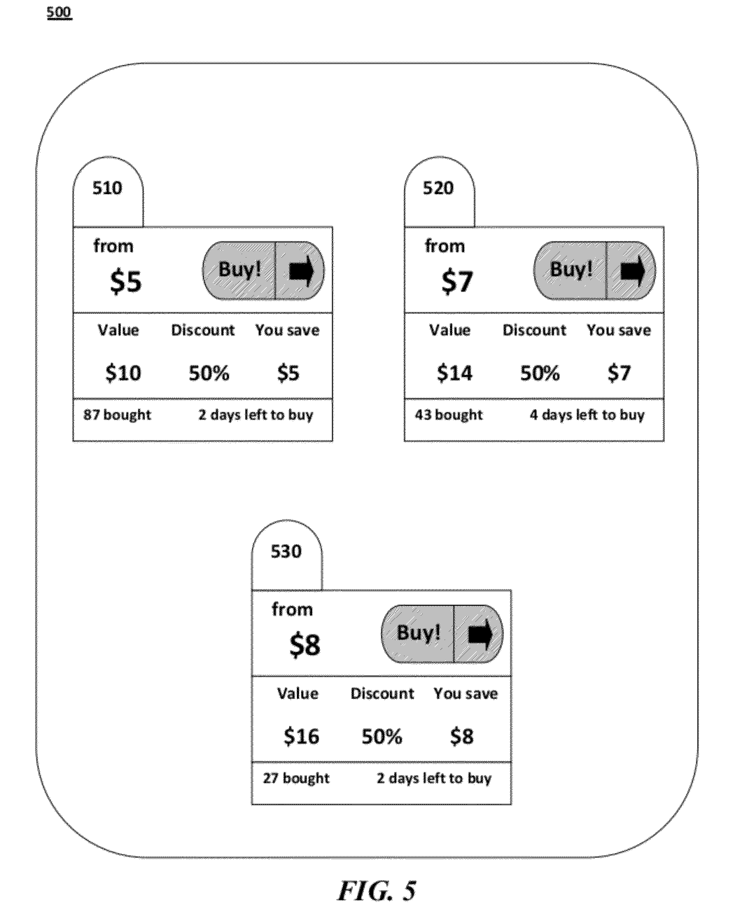

### FIG. 5

### Aggregator Site

Referring now to FIG. 5, in another example, multiple “deal offerings” 510, 520, and 530 for related products (e.g., Living Social, Groupon, etc.), may be aggregated onto a single “aggregator” site 500. Thus, the inputs used to revise prices for an item may be readily apparent to a prospective buyer. For example, as shown in FIG. 5, meal deals offered by multiple competitors can be aggregated and displayed on a single site so that shoppers can easily comparison shop. Additionally, the aggregated site provides the added benefit of empowering the shoppers as they witness the effect their purchases and/or bids have on pricing.

FIG. 5 shows a $5 deal 510 from Groupon for a meal valued at $10 at Applebee's presented alongside a $7 deal 520 from Living Social for a meal valued at $14 at TGI Friday's and a $8 deal 530 from Yahoo! Deals for a meal valued at $16 at Denny's. In this example, a high volume of sales on the Groupon offering could be used to automatically lower the price of the other offerings to, e.g., $6.50 at Living Social and/or $7.25 at Yahoo! Deals.

Therefore, while there has been described what is presently considered to be the preferred embodiment, it will understood by those skilled in the art that other modifications can be made within the spirit of the invention. The above description(s) of embodiment(s) is not intended to be exhaustive or limiting in scope. The embodiment(s), as described, were chosen in order to explain the principles of the invention, show its practical application, and enable those with ordinary skill in the art to understand how to make and use the invention. It should be understood that the invention is not limited to the embodiment(s) described above, but rather should be interpreted within the full meaning and scope of the appended claims.

I claim:

1. A computer-implemented method for real-time pricing comprising:
using an input/output interface receiving current sales data for an item, said sales data comprising a sales price of said item, and a time of sale of the item;
using a processor device configured to perform:
storing the current sales data;
calculating a current sales lag time as a time elapsed between the sale of the item and a previous sale of said item;
comparing the current sales lag time with a stored historical sales lag time for the item;
determining that the sales lag time is increasing when the current sales lag time is greater than the stored historical sales lag time of the item; and
recommending a decrease in the sales price of the item when it is determined that the sales lag time is increasing.

2. The computer-implemented method of claim 1 further comprising:
receiving data indicating a size of a competitor's customer queue; and
factoring the size of the competitor's queue in any decision made to adjust the sales price.

3. The computer-implemented method of claim 1 further comprising:
determining that the sales lag time is decreasing when the current sales lag time is less than the stored historical sales lag time of the item; and
recommending an increase in the sales price of the item when the current sales lag time is lower than the stored historical sales lag time of the item.

4. The computer-implemented method of claim 3 further comprising:
determining that the increase in the sales price does not place an increased sales price above an upper limit price cap; and
determining that the decrease in the sales price does not place a decreases sales price below a lower limit price cap.

5. The computer-implemented method of claim 1 further comprising storing the historical sales lag time.

6. The computer-implemented method of claim 5 wherein storing the historical sales lag time as the sales lag time between a last sale of the item and a penultimate sale of the item.

7. The computer-implemented method of claim 5 wherein storing the historical sales lag time comprises:
recording the sales lag time for sales of the item for a specified period of time; and
computing the historical sales lag time as an average of lag times for sales of the item during the specified period of time.

8. The computer-implemented method of claim 3 further comprising setting a price increment representing how much to increase and decrease the sales price.

9. A system for real-time pricing comprising:
an input/output interface configured to receive current sales data for an item, said sales data comprising a sales price of said item, and a time of sale of the item;
a memory storing computer executable instructions; and
a processor device operably coupled with the memory for executing the computer executable instructions causing a computer to perform steps of:
storing the current sales data;
calculating a current sales lag time as a time elapsed between the sale of the item and a previous sale of said item;
comparing the current sales lag time with a stored historical sales lag time for the item;
determining that the sales lag time is increasing when the current sales lag time is greater than the stored historical sales lag time of the item; and
recommending a decrease in the sales price of the item when it is determined that the sales lag time is increasing.

10. The system of claim 9 further comprising storage storing the current sales data and historical sales lag time.

11. The system of claim 10 wherein storing the historical sales lag time comprises storing the sales lag time between a last sale of the item and a penultimate sale of the item.

12. The system of claim 10 wherein storing the historical sales lag time comprises:
recording the sales lag time for sales of the item for a specified period of time; and
computing the historical sales lag time as an average of lag times for sales of the item during the specified period of time.

13. The system of claim 9 wherein the input/output interface is further configured to receive a price increment representing how much to increase and decrease the sales price.

14. The system of claim 9 wherein the processor device is further configured to recommend an increase in the sales price of the item when the current sales lag time is lower than the stored historical sales lag time of the item.

15. The system of claim 14 wherein the processor device is further configured to:
determine that the decrease in the sales price does not place a decreased sales price below a lower limit price cap;
determine that the increase in the sales price does not place an increased sales price above an upper limit price cap;
determine that the sales lag time is decreasing when the current sales lag time is less than the stored historical sales lag time of the item; and
recommend an increase in the sales price of the item when the current sales lag time is lower than the stored historical sales lag time of the item.

16. A non-transitory computer readable storage medium comprising computer executable instructions that when executed, cause a computer to perform steps of:
receiving current sales data for an item, said sales data comprising a sales price of said item, and a time of sale of the item;
storing the current sales data;
calculating a current sales lag time as a time elapsed between the sale of the item and a previous sale of said item;
comparing the current sales lag time with a stored historical sales lag time for the item;
determining that the sales lag time is increasing when the current sales lag time is greater than the stored historical sales lag time of the item; and
recommending a decrease in the sales price of the item when it is determined that the sales lag time is increasing.

17. The non-transitory computer readable storage medium of claim 16 wherein the computer executable instructions, when executed, further cause the computer to perform steps of:
determining that the sales lag time is decreasing when the current sales lag time is less than the stored historical sales lag time of the item; and
recommending an increase in the sales price of the item when the current sales lag time is lower than the stored historical sales lag time of the item.

18. The non-transitory computer readable storage medium of claim 17 wherein the computer executable instructions, when executed, further cause the computer to perform steps of:
determining that the increase in the sales price does not place an increased sales price above an upper limit price cap; and
determining that the decrease in the sales price does not place a decreased sales price below a lower limit price cap.

19. The non-transitory computer readable storage medium of claim 18 wherein the computer executable instructions, when executed, further cause the computer to receive a price increment representing how much to increase and decrease the sales price.

20. The computer-implemented method of claim 1 further comprising:
aggregating the sales price of the item along with sales prices of related items sold by competitors; and
presenting the aggregated sales price information, along with product and seller information, on one site.
